(19) United States
(12) Patent Application Publication
(10) Pub. No.: US 2014/0212781 A1
(43) Pub. Date: Jul. 31, 2014

(54) STACKED TYPE FUEL CELL

(71) Applicant: Industrial Technology Research Institute, Hsinchu (TW)

(72) Inventors: Li-Duan Tsai, Hsinchu City (TW); Ching-Jung Liu, Hsinchu County (TW); Chun-Ho Tai, Hsinchu City (TW); Ku-Yen Kang, Hsinchu City (TW)

(73) Assignee: Industrial Technology Research Institute, Hsinchu (TW)

(21) Appl. No.: 14/243,897

(22) Filed: Apr. 3, 2014

Related U.S. Application Data
(63) Continuation-in-part of application No. 13/030,149, filed on Feb. 18, 2011.

(30) Foreign Application Priority Data
Dec. 16, 2010 (TW) 99144306
Dec. 24, 2013 (TW) 102148015

(51) Int. Cl. H01M 8/02; H01M 8/24; H01M 8/04

(52) U.S. Cl. CPC H01M 8/0258; H01M 8/04291; H01M 8/2465; H01M 8/0247; H01M 8/04701
USPC 429/434; 429/457

(57) ABSTRACT

A stacked type fuel cell includes electricity generating modules, at least two cathode flow field plates, and at least one common anode flow field plate. Each electricity generating module includes an anode collector, a cathode collector, a membrane electrode assembly (MEA) between the anode collector and the cathode collector, a fuel diffusion layer, and a cathode moisture layer. The fuel diffusion layer and the cathode moisture layer are respectively located at two sides of the MEA. The anode collector is between the fuel diffusion layer and the MEA, and the cathode collector is between the cathode moisture layer and the MEA. The common anode flow field plate is between two fuel diffusion layers in two adjacent electricity generating modules. The common anode flow field plate and two electricity generating modules located at two sides of the common anode flow field plate are sandwiched between the cathode flow field plates.

### CROSS-REFERENCE TO RELATED APPLICATION

This application is a continuation-in-part application of and claims the priority benefit of a prior application Ser. No. 13/030,149, filed on Feb. 18, 2011, now pending. The prior application Ser. No. 13/030,149 claims the priority benefit of Taiwan application serial no. 99144306, filed on Dec. 16, 2010. This continuation-in-part also claims the priority benefit of Taiwan application serial no. 102148015, filed on Dec. 24, 2013. The entirety of each of the above-mentioned patent applications is hereby incorporated by reference herein and made a part of this specification.

### TECHNICAL FIELD

The technical field relates to a stacked type fuel cell.

### BACKGROUND

With the rapid development of industry, the consumption of conventional energy source, such as coal, petroleum, and natural gas, is increasingly high, and the limited natural energy sources necessitate the development of novel alternative energy sources in replacement of the conventional energy sources. A fuel cell, one of the alternative energy sources, is taken as an important and practical choice.

In brief, the fuel cell is basically a power generator that converts chemical energy into electrical energy through a reverse reaction of water electrolysis. For instance, a proton exchange membrane fuel cell is mainly composed of a membrane electrode assembly (MEA) and two electrode plates. The MEA often includes a proton exchange membrane, an anode catalyst layer, a cathode catalyst layer, an anode gas diffusion layer (GDL), and a cathode GDL. The anode catalyst layer and the cathode catalyst layer are respectively located at two sides of the proton conducting membrane, and the anode GDL and the cathode GDL are respectively located on the anode catalyst layer and the cathode catalyst layer. Besides, the two electrode plates include an anode and a cathode that are respectively located on the anode GDL and the cathode GDL.

Currently, the common proton exchange membrane fuel cell is the direct methanol fuel cell (DMFC) that uses the methanol aqueous solution as the fuel supply source and generates currents through the relevant electrode reaction between methanol and oxygen. The reaction formulas of the DMFC are shown below:

Anode: CH₃OH+H₂O→CO₂+6H⁺+6e⁻

Cathode: 3/2O₂+6H⁺+6e⁻→3H₂O

During reaction, the concentration of methanol and water in the anode must be kept to a proper level. In theory, the concentration ratio of methanol to water is 1 mole: 1 mole. However, the MEA is unable to prevent such a high concentration methanol aqueous solution from crossing over to the cathode; therefore, in the conventional fuel cell system, the cathode water is collected from the cathode with a condenser, and the collected cathode water is delivered back to the fuel mixing tank at the anode. With a fuel concentration detector, a fuel cycle pump, a high concentration methanol replenishment pump, and other devices, the concentration of the methanol aqueous solution in the anode is controlled to fall within a range from 2% to 6%. Such fuel cell system is referred to as an active fuel cell system.

In recent years, a passive fuel cell system has been developed. Specifically, the moisture at the cathode is adjusted to differentiate the concentration gradient of water at the anode from the concentration gradient of water at the cathode, and thus the cathode water penetrates the MEAs and is delivered back to the anode for further recycling. Such a technique has been proven feasible. In said passive fuel cell system, neither a condenser nor other water recycling devices are required to be set at the cathode, and complicated devices (e.g., a fuel mixing tank) are not required to be set at the anode. What is required is a micro pump for timely supplying the proper amount of high concentration methanol to the anode. Although the structure of said passive fuel system is rather simple, such a fuel cell system can operate in a stable manner. Unfortunately, the required concentration of fuel supplied to the anode of the passive fuel cell is rather high, i.e., at least 50%, and the fuel supplied to the anode is not recycled and thus cannot be re-used. Hence, the flow rate of the fuel supply is low, approximately 0.5 μL/min per square centimeter of reaction area, and thus it is difficult to evenly distribute such a small amount of fuel onto the entire reaction area, especially in the multi-module system with high power output. Besides, in the passive fuel cell system, material layers with different characteristics are utilized for evenly distributing the fuel at the anode end and facilitating the water recycling at the cathode end. These material layers in the passive fuel cell system complicate the process of assembling the electricity generating modules, and the incapability of effectively utilizing space in the passive fuel cell system may also be attributed to the material layers. Thereby, the passive fuel cell system is difficult to be applied in case of the high power output.

A conventional fuel cell often has the bipolar plates stacked together, i.e., flow field plates not only provide the fuel channels at the anode and the cathode but also serve as collectors after plural membrane electrode assemblies (MEAs) are serially connected. Said design of stacked bipolar plates allows the MEAs to be assembled compactly. Nevertheless, in the passive fuel cell system, the non-conductive material layers prevent the MEAs from being directly connected in series along a direction that the MEAs are stacked. Additionally, at the anode end, the liquid fuel with an extremely small flow rate cannot be well spread onto the fuel channels along said direction. As a result, the conventional design of stacked bipolar plates cannot be adopted in the passive fuel cell system.

In a passive DMFC, plural MEAs are arranged in array, as disclosed in patent applications Nos. WO2008105272 and TW201228085, wherein the design of the fuel channel allows the fuel at the anode end to be evenly distributed onto a reaction plane. Such design is applicable to the fuel cell with one single reaction plane. However, in a fuel cell system with high power output requirements, more space for accommodating plural fuel cells with one single reaction plane is required; what is more, the issue as how to evenly deliver the fuel with the low flow rate into the fuel channels remains unresolved.

### SUMMARY

One of exemplary embodiments provides a stacked type fuel cell having a common anode flow field plate.

In an exemplary embodiment, a stacked type fuel cell that includes at least two electricity generating modules, at least two cathode flow field plates, and at least one common anode flow field plate is provided. Each of the electricity generating modules includes an anode collector, a cathode collector, a membrane electrode assembly (MEA) between the anode collector and the cathode collector, a fuel diffusion layer, and a cathode moisture layer. The fuel diffusion layer and the cathode moisture layer are respectively located at two sides of the MEA. The anode collector is located between the fuel diffusion layer and the MEA, and the cathode collector is located between the cathode moisture layer and the MEA. The common anode flow field plate is located between two fuel diffusion layers in two adjacent electricity generating modules. The common anode flow field plate and two electricity generating modules located at two sides of the common anode flow field plate are sandwiched between the cathode flow field plates.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view illustrating a stacked type fuel cell according to an exemplary embodiment.

FIG. 2 is a schematic explosive view illustrating a stacked type fuel cell according to an exemplary embodiment.

FIG. 3 is a schematic three-dimensional view illustrating a stacked type fuel cell according to an exemplary embodiment.

FIG. 4A to FIG. 4C are schematic cross-sectional views illustrating several common anode flow field plates.

### DETAILED DESCRIPTION OF DISCLOSED EMBODIMENTS

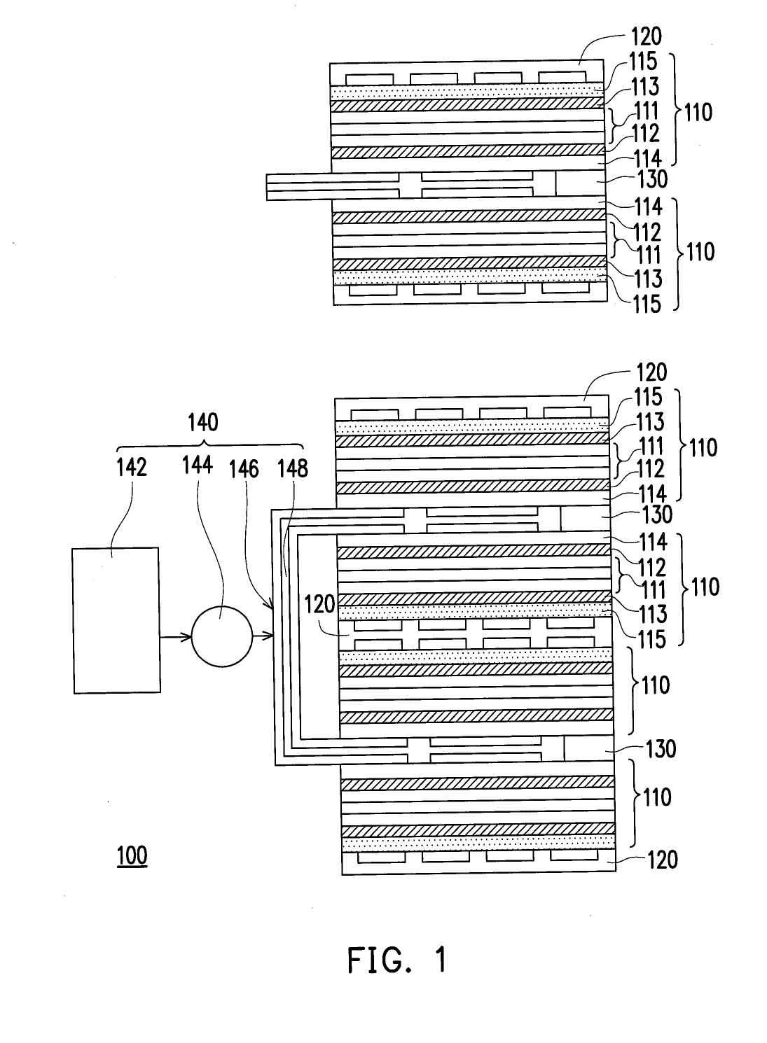

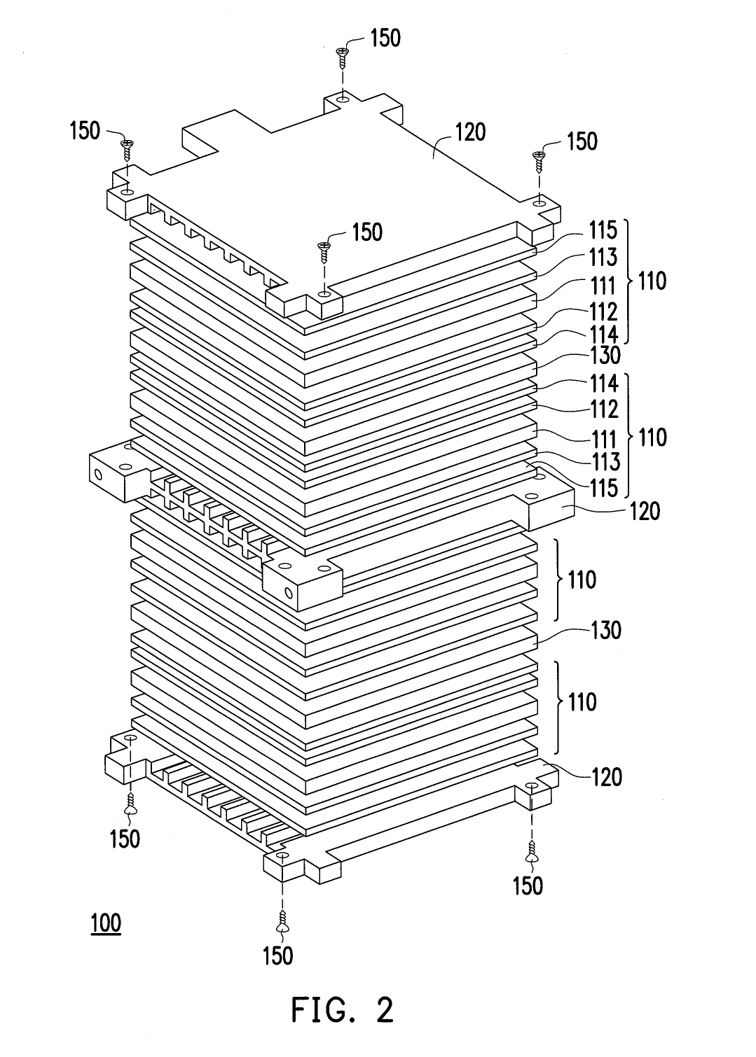

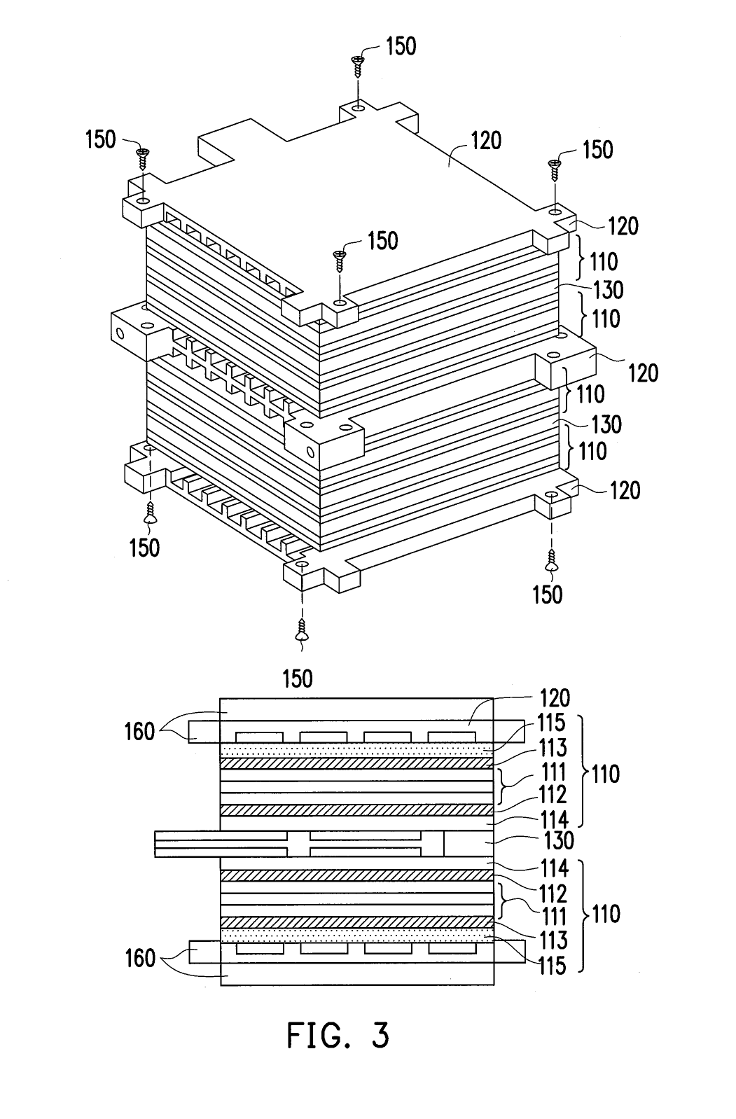

FIG. 1 is a schematic cross-sectional view illustrating a stacked type fuel cell according to an exemplary embodiment. FIG. 2 is a schematic explosive view illustrating a stacked type fuel cell according to an exemplary embodiment. FIG. 3 is a schematic three-dimensional view illustrating a stacked type fuel cell according to an exemplary embodiment. With reference to FIG. 1 to FIG. 3, the stacked type fuel cell 100 provided in the present exemplary embodiment includes a plurality of electricity generating modules 110, at least two cathode flow field plates 120, and at least one common anode flow field plate 130. Each of the electricity generating modules 110 in the stacked type fuel cell 100 includes an anode collector 112, a cathode collector 113, a membrane electrode assembly (MEA) 111 between the anode collector 112 and the cathode collector 113, a fuel diffusion layer 114, and a cathode moisture layer 115. The fuel diffusion layer 114 and the cathode moisture layer 115 are respectively located at two sides of the MEA 111. The anode collector 112 is located between the fuel diffusion layer 114 and the MEA 111, and the cathode collector 113 is located between the cathode moisture layer 115 and the MEA 111. The common anode flow field plate 130 is located between two fuel diffusion layers 114 in two adjacent electricity generating modules 110. The common anode flow field plate 130 and two electricity generating modules 110 located at two sides of the common anode flow field plate 130 are sandwiched between two adjacent cathode flow field plates 120. The fuel diffusion layer 114 is, for instance, made of a woven fiber, a non-woven fiber, paper, foam, foamed PE, formed PU, etc. The materials of the fuel diffusion layer 114 are capable of absorbing fuel without conducting electricity; thereby, fuel at the outlets of the common anode flow field plate 130 may be further diffused evenly, and the fuel distribution issue resulted from the small quantity of outlets of the common anode flow field plate 130 may be resolved. The cathode moisture layer 115 mainly serves to control the evaporation speed of water generated at the cathode end after reaction, and the cathode moisture layer 115 may be made of a gas barrier material suitable for fabrication of apertures, such as polymer or metal. A thickness of the cathode moisture layer 115 is between 10 μm and 2 mm, for instance. In another exemplary embodiment, the thickness of the cathode moisture layer 115 is between about 10 μm and about 500 μm. The cathode moisture layer 115 has at least one aperture (not shown), so as to control gas permeability, and the overall aperture ratio is within a range from 0.5% to 30%. In another exemplary embodiment, the overall aperture ratio is within a range from about 2% to about 10%, for instance.

In the present exemplary embodiment, the common anode flow field plate 130 allows the space utilization rate of the stacked type fuel cell 100 to be increased. Besides, each common anode flow field plate 130 may supply fuel simultaneously to the electricity generating modules 110 located at two sides of the common anode flow field plate 130, and thus the fuel supplied to the electricity generating modules 110 is not distributed in an uneven manner.

In addition to the electricity generating modules 110, the cathode flow field plates 120, and the common anode flow field plate 130, the stacked type fuel cell 100 described in the present exemplary embodiment may further include a fuel supply unit 140 that includes a fuel storage tank 142, a pump 144, and a main channel 146. The fuel storage tank 142 is adapted to store a fuel, and the main channel 146 is connected between two common anode flow field plates 130. The fuel stored in the fuel storage tank 142 is supplied to the two common anode flow field plates 130 through the pump 144 and the main channel 146. Note that the main channel 146 is filled with a filler 148, and a capillary force provided by the filler 148 may lessen the impact of gravity on fuel with the low flow rate, such that the fuel in the main channel 146 may be evenly supplied to the two common anode flow field plates 130. According to the present exemplary embodiment, the filler 148 is, for instance, a capillary material (e.g., a woven fiber, a non-woven fiber, paper, foam, foamed PE, foamed PU, etc.) or any other “fuel-philic” material. For instance, the contact angle between the filler 148 and the fuel (e.g., methanol) is less than 90 degrees, i.e., the filler 148 has “fuel-philic” properties.

Since the main channel 146 is filled with the filler 148, the fuel flowing into the main channel 146 can be easily introduced into the common anode flow field plate 130 through the filler 148.

As shown in FIG. 1, the number of the pump 144 is less than or equal to the number of the common anode flow field plate 130. Specifically, the number of the pump 144 is N1, the number of the common anode flow field plate 130 is N2, and N1 and N2 satisfy N1=N2/n. Here, (N2/n) is a positive integer, and n is a positive integer smaller than 3. According to the present exemplary embodiment, through the branch design of the main channel 146 and the design of the common anode flow field plate 130, one single pump 144 is able to provide fuel to four electricity generating modules 110; at this time, the number of the pump 144 in use is one fourth the number of the electricity generating modules 110. Certainly, if the branch design is not adopted by the main channel 146 (i.e., only the design of the common anode flow field plate 130 is applied), one single pump 144 is still able to provide fuel to two electricity generating modules 110; at this time, the number of the pump 144 in use is one second the number of the electricity generating modules 110.

The stacked type fuel cell 100 described in the present exemplary embodiment is a passive fuel cell; hence, fuel introduced to the stacked type fuel cell 100 is required to have high concentration, and the flow rate of fuel in the common anode flow field plate 130 is rather low. In the present exemplary embodiment, the concentration of the fuel is greater than 50%, for instance; in other feasible exemplary embodiments, the concentration of the fuel introduced into the stacked type fuel cell 100 is greater than 70%. Besides, the flow rate of fuel in the common anode flow field plate 130 is proportional to the reaction area of the MEAs 111. For instance, the fuel supplied to each of the MEAs 111 has a flow rate per square centimeter of reaction area, and the flow rate is between 3 μL/min and 0.1 μL/min; in other feasible exemplary embodiments, said flow rate is between 2 μL/min to 0.1 μL/min, for instance.

In most cases, if the total area of the MEAs 111 increases, it is rather difficult for the common anode flow field plate 130 to evenly distribute the fuel. An area of the common anode flow field plate 130 is frequently smaller than 250 cm², preferably smaller than 100 cm². According to the present exemplary embodiment, one common anode flow field plate 130 is able to evenly distribute the fuel to two neighboring MEAs 111, and therefore the flow rate of the fuel in the common anode flow field plate 130 is smaller than 1500 μL/min, preferably smaller than 600 μL/min.

As shown in FIG. 1 to FIG. 3, the stacked type fuel cell 100 described in the present exemplary embodiment may further include a plurality of locking components 150 locked onto the cathode flow field plates 120, such that the common anode flow field plate 130 and the electricity generating modules 110 are fixed (stably clamped) between the cathode flow field plates 120. Note that the thickness of the common anode flow field plate 130 may not be the same as the thickness of the cathode flow field plates 120; in most cases, the thickness of the common anode flow field plate 130 is less than the thickness of the cathode flow field plates 120, as provided in the present exemplary embodiment.

The stacked type fuel cell 100 described herein may further include a heat sink 160 that is located on outer surfaces of the cathode flow field plates 120, so as to dissipate the heat of the stacked type fuel cell 100.

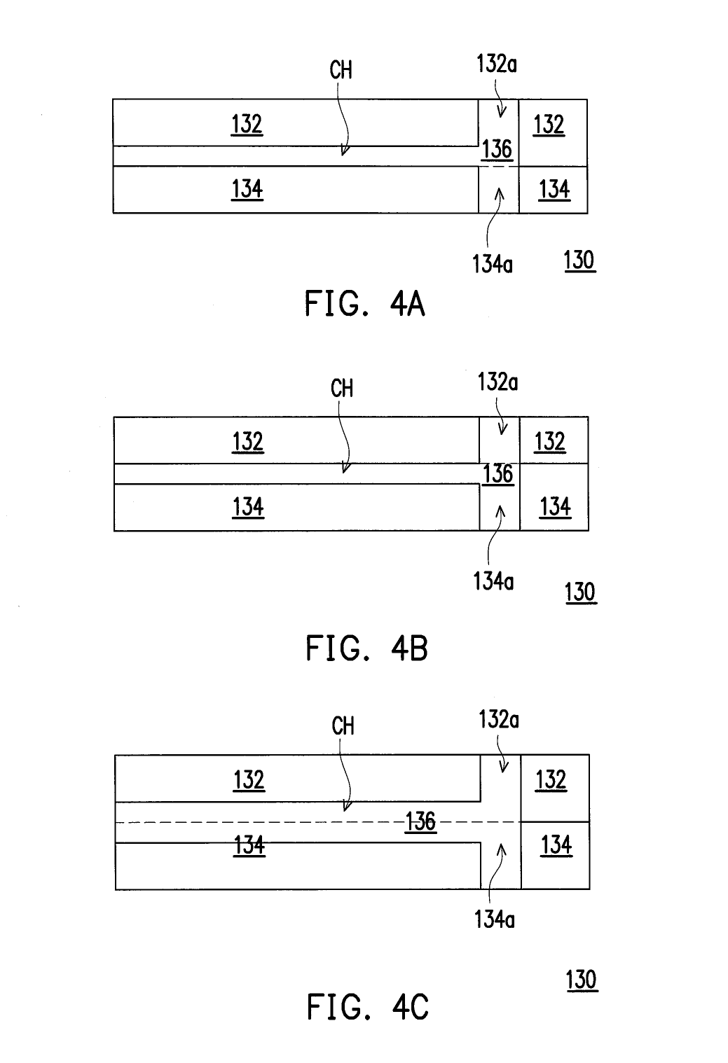

Several designs of different common anode flow field plates 130 are described hereinafter with reference to FIG. 4A to FIG. 4C.

FIG. 4A to FIG. 4C are schematic cross-sectional views illustrating several common anode flow field plates. As shown in FIG. 4A, the common anode flow field plate 130 provided in the present exemplary embodiment includes a first material layer 132, a second material layer 134, and a filler 136. The first material layer 132 has a plurality of first fuel outlets 132a, and the second material layer 134 has a plurality of second fuel outlets 134a. A patterned channel CH is located between the first material layer 132 and the second material layer 134, a distribution range of the patterned channel CH covers the first fuel outlets 132a and the second fuel outlets 134a, and the patterned channel CH communicates with the first fuel outlets 132a and the second fuel outlets 134a. Besides, the filler 136 fills the patterned channel CH. In the present exemplary embodiment, the overall thickness of the common anode flow field plate 130 is less than 5 mm, preferably less than 2 mm. Besides, the width of each channel in the common anode flow field plate 130 is between 0.5 mm to 10 mm, for instance; in other feasible exemplary embodiments, the width of each channel is between 1 mm to 5 mm, and the area of the first fuel outlets 132a and the second fuel outlets 134a is between 3 mm² to 100 mm², for instance. As to the distribution density of the first fuel outlets 132a and the second fuel outlets 134a, there exists at least one fuel outlet per 20 cm² of reaction area of the MEAs 111.

The capillary force provided by the filler 136 may lessen the impact of gravity on fuel with the low flow rate. According to the present exemplary embodiment, the filler 136 is, for instance, a capillary material (e.g., a woven fiber, a non-woven fiber, paper, foam, foamed PE, foamed PU, etc.) or any other appropriate material. For instance, the contact angle between the filler 136 and the fuel (e.g., methanol) is less than 90 degrees, i.e., the filler 136 has “fuel-philic” properties. Besides, since the patterned channel CH is filled with the filler 136, the fuel flowing into the common anode flow field plate 130 can be easily introduced into the electricity generating modules 110 through the filler 136.

In the present exemplary embodiment, the filler 136 filling the patterned channel CH may be the same as the filler 148 filling the main channel 146. Certainly, people having ordinary skill in the pertinent art may, according to the actual design requirements, differentiate the filler 136 from the filler 148.

Note that the location of the filler 136 may be modified according to actual design requirements of the stacked type fuel cell 100. For instance, people having ordinary skill in the pertinent art may fill the entire patterned channel CH with the filler 136; thus, parts of the patterned channel CH corresponding to the first and second fuel outlets 132a and 134b are filled with the filler 136 as well, and the filler 136 are exposed by the first and second fuel outlets 132a and 134b. In another embodiment, people having ordinary skill in the pertinent art may fill only parts of the patterned channel CH filled with the filler 136, specifically, the other parts of the patterned channel CH corresponding to the first and second fuel outlets 132a and 134b are not filled with the filler 136.

As shown in FIG. 4A to FIG. 4C, the patterned channel CH provided in the present exemplary embodiment may be formed in the first material layer 132 (shown in FIG. 4A), in the second material layer 134 (shown in FIG. 4B), or formed in both the first material layer 132 and the second material layer 134 (shown in FIG. 4C). According to the present exemplary embodiment, the first material layer 132 and the second material layer 134 may be made of any gas-impermeable material, such as metal, plastic, and so on. The first material layer 132 and the second material layer 134 are joined by performing a welding process. Since the common anode flow field plate 130 is sealed by performing the soldering process or the fusing process in advance, the reliability of sealing may be effectively improved, and the common anode flow field plate 130 may be further thinned out (i.e., the common anode flow field plate 130 is not necessarily bulky). That is, the conventional stacked structure is assembled and sealed by compressing thick and heavy end plates; by contrast, the stacked type fuel cell 100 described in the present exemplary embodiment can be completely assembled merely by closely arranging the cathode flow field plates 120.

It will be apparent to those skilled in the art that various modifications and variations can be made to the structure of the disclosed embodiments without departing from the scope or spirit of the disclosure. In view of the foregoing, it is intended that the disclosure cover modifications and variations of the disclosure provided they fall within the scope of the following claims and their equivalents.

What is claimed is:

1. A stacked type fuel cell, comprising:
a plurality of electricity generating modules, each of the electricity generating modules comprising:
an anode collector;
a cathode collector;
a membrane electrode assembly located between the anode collector and the cathode collector; and
a fuel diffusion layer;
a cathode moisture layer, the fuel diffusion layer and the cathode moisture layer being respectively located at two sides of the membrane electrode assembly, the anode collector being located between the fuel diffusion layer and the membrane electrode assembly, the cathode collector being located between the cathode moisture layer and the membrane electrode assembly;
at least two cathode flow field plates; and
at least one common anode flow field plate located between two of the fuel diffusion layers in two adjacent electricity generating modules of the electricity generating modules, the at least one common anode flow field plate and two of the electricity generating modules of the electricity generating modules located at two sides of the at least one common anode flow field plate being sandwiched between the at least two cathode flow field plates.

2. The stacked type fuel cell according to claim 1, wherein the at least one common anode flow field plate comprises:
a first material layer having a plurality of first fuel outlets;
a second material layer having a plurality of second fuel outlets, a patterned channel being located between the first material layer and the second material layer, a distribution range of the patterned channel covering the first fuel outlets and the second fuel outlets, the patterned channel communicating with the first fuel outlets and the second fuel outlets; and
a filler filling the patterned channel.

3. The stacked type fuel cell according to claim 2, wherein the first fuel outlets and the second fuel outlets are filled with the filler.

4. The stacked type fuel cell according to claim 2, wherein the patterned channel is formed in the first material layer or the second material layer.

5. The stacked type fuel cell according to claim 2, wherein the patterned channel is formed in the first material layer and the second material layer.

6. The stacked type fuel cell according to claim 2, wherein the first material layer and the second material layer are joined by a welding process.

7. The stacked type fuel cell according to claim 1, further comprising a fuel supply unit, the fuel supply unit comprising:
a fuel storage tank adapted to store a fuel;
a pump;
a main channel connected to the at least one common anode flow field plate, the fuel stored in the fuel storage tank being supplied to the common anode flow field plates through the pump and the main channel.

8. The stacked type fuel cell according to claim 7, wherein the main channel is filled with a filler.

9. The stacked type fuel cell according to claim 7, wherein the number of the pump is N1, the number of the at least one common anode flow field plate is N2, and N1 and N2 satisfy N1=N2/n,
wherein (N2/n) is a positive integer, and n is a positive integer smaller than 3.

10. The stacked type fuel cell according to claim 7, wherein a concentration of the fuel is greater than 50%.

11. The stacked type fuel cell according to claim 7, wherein a concentration of the fuel is greater than 70%.

12. The stacked type fuel cell according to claim 1, wherein fuel supplied to each of the membrane electrode assemblies has a flow rate per square centimeter of reaction area, and the flow rate is between 3 μL/min and 0.1 μL/min.

13. The stacked type fuel cell according to claim 1, wherein fuel supplied to each of the membrane electrode assemblies has a flow rate per square centimeter of reaction area, and the flow rate is between 2 μL/min to 0.1 μL/min.

14. The stacked type fuel cell according to claim 1, wherein a thickness of the at least one common anode flow field plate is smaller than 5 mm.

15. The stacked type fuel cell according to claim 1, wherein an area of the at least one common anode flow field plate is smaller than 250 cm².

16. The stacked type fuel cell according to claim 1, wherein a flow rate of a fuel in the at least one common anode flow field plate is smaller than 1500 μL/min.

17. The stacked type fuel cell according to claim 1, further comprising a plurality of locking components locked onto the at least two cathode flow field plates, such that the at least one common anode flow field plate and the electricity generating modules are fixed between the at least two cathode flow field plates.

18. The stacked type fuel cell according to claim 1, further comprising a heat sink located on the at least two cathode flow field plates.
